(19) United States
(12) Patent Application Publication
(10) Pub. No.: US 2025/0190014 A1
(43) Pub. Date: Jun. 12, 2025

(54) Bezel-Less Display Mounts

(71) Applicant: Google LLC, Mountain View, CA (US)

(72) Inventors: Yongho Lim, Kildeer, IL (US); Avi Pinchas Hecht, San Francisco, CA (US); Yiting Liu, New Taipei City (TW); Michael J. Lombardi, South Barrington, IL (US); Shao Tai Lu, Zhubei City (TW)

(73) Assignee: Google LLC, Mountain View, CA (US)

(21) Appl. No.: 19/056,567

(22) Filed: Feb. 18, 2025

Related U.S. Application Data
(60) Provisional application No. 63/759,369, filed on Feb. 17, 2025.

(51) Int. Cl. G06F 1/16

(52) U.S. Cl. CPC G06F 1/1616; G06F 1/1656

(57) ABSTRACT

This document describes systems and techniques directed at bezel-less display mounts for foldable electronic devices. In aspects, a foldable electronic device includes a housing with a display recess that includes an inwardly projecting ledge. A foldable display structure, which includes a display panel and a cover layer, is positioned in the display recess. In aspects, the cover layer includes a variable thickness along at least one dimension. The cover layer defines an extension portion that extends beyond one or more edges of the display panel. A back adhesive portion is disposed between the bottom face of the display panel and the bottom of the housing and a perimeter adhesive portion is disposed between the extension portion of the cover layer and the ledge. In this way, the foldable electronic device can do away with a bezel (e.g., display trim) that would otherwise surround a perimeter of the display panel.

### CROSS-REFERENCE TO RELATED APPLICATION

This application claims the benefit of U.S. Provisional Patent Application Ser. No. 63/759,369 filed on Feb. 17, 2025, the disclosure of which is incorporated by reference herein in its entirety.

### SUMMARY

This document describes systems and techniques directed at bezel-less display mounts for foldable electronic devices. In aspects, a foldable electronic device includes a housing with opposing side walls, opposing end walls, and a bottom that interconnects the opposing side walls and the opposing end walls. The foldable electronic device includes a display recess defined between the opposing side walls, opposing end walls, and a bottom of the housing. The display recess may include a ledge that inwardly projects from at least one of the opposing side walls or the opposing end walls. The foldable electronic device includes a folding region that intersects a first non-folding region and a second non-folding region. At least one of the first non-folding region or the second non-folding region is configured to rotate about the folding region. The foldable electronic device includes a foldable display structure positioned in the display recess within at least portions of the first non-folding region of the housing and/or the second non-folding region of the housing. The foldable display structure includes a display panel and a cover layer.

The display panel includes a top face, a bottom face opposite the top face, and a plurality of light-emitting pixels disposed in the display panel. The cover layer is positioned as the topmost layer of the foldable display structure and includes a variable thickness along at least one dimension. The cover layer has a top face and a bottom face. The bottom face of the cover layer has an area larger than the top face of the display panel to define an extension portion that extends beyond one or more edges of the display panel. The foldable electronic device includes a back adhesive portion disposed between the bottom face of the display panel and the bottom of the housing, and a perimeter adhesive portion disposed between the extension portion of the cover layer and the ledge. Through such an implementation, the display panel of the foldable electronic device may be protected by the cover glass and ingress of contaminants limited. As a result, the foldable electronic device can do away with a bezel (e.g., display trim) that would otherwise surround a perimeter of the display panel.

This Summary is provided to introduce simplified concepts of systems and techniques directed at bezel-less display mounts for foldable electronic devices, the concepts of which are further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of systems and techniques directed at bezel-less display mounts for foldable electronic devices are described in this document with reference to the following Drawings, in which the use of the same numbers in different instances may indicate similar features and/or components.

FIG. 1 illustrates a prior art foldable electronic device that includes a bezel surrounding a perimeter of a display;

FIG. 2 is an exploded, perspective view of a bezel-less display mount for foldable electronic devices in accordance with one or more implementations;

FIG. 3 is a bottom side view of a foldable display structure of a foldable electronic device in which bezel-less display mounts for foldable electronic devices in accordance with one or more implementations;

FIG. 4 is a partial, bottom side view of the foldable display structure of FIG. 3;

FIG. 5A is an exploded, partial cross-sectional view along lines 5-5 in FIG. 4, including a housing;

FIG. 5B is a partial cross-sectional view along lines 5-5 in FIG. 4, illustrating the assembled foldable electronic device;

FIG. 6A is an exploded, partial cross-sectional view along lines 6-6 in FIG. 4, including the housing;

FIG. 6B is a partial cross-sectional view along lines 6-6 in FIG. 4, illustrating the assembled foldable electronic device;

FIG. 7 is a schematic illustration of an example variable thickness cover layer for bezel-less display mounts for foldable electronic devices in accordance with one or more implementations; and

FIG. 8 is a schematic illustration of example foldable electronic devices in which bezel-less display mounts can be implemented.

### DETAILED DESCRIPTION

### Overview

Many electronic devices include displays (e.g., light-emitting diode (LED) displays, liquid crystal displays (LCDs)). Electronic device manufacturers often fabricate displays in a layered structure (“display panel stack”). A display panel stack may include layers of a display panel that, when integrated into an electronic device, is disposed underneath, and shielded by, a cover layer (e.g., a glass layer, a cover glass).

To provide users with large display experiences in small product form factors, manufacturers may design electronic devices, including at least portions of display panel stacks, to fold into one or more configurations (“foldable electronic devices”). A foldable electronic device, with a foldable display, can include one or more folding regions about which one or more non-folding regions may rotate. The non-folding regions may fold towards or away from each other to achieve one of a variety of foldable display shapes, such as a ‘Z’ shape or ‘C’ shape. Commonly, a foldable display includes one primary folding region that divides the display into two equal segments (e.g., non-folding regions) that are generally equidistant from the primary folding region.

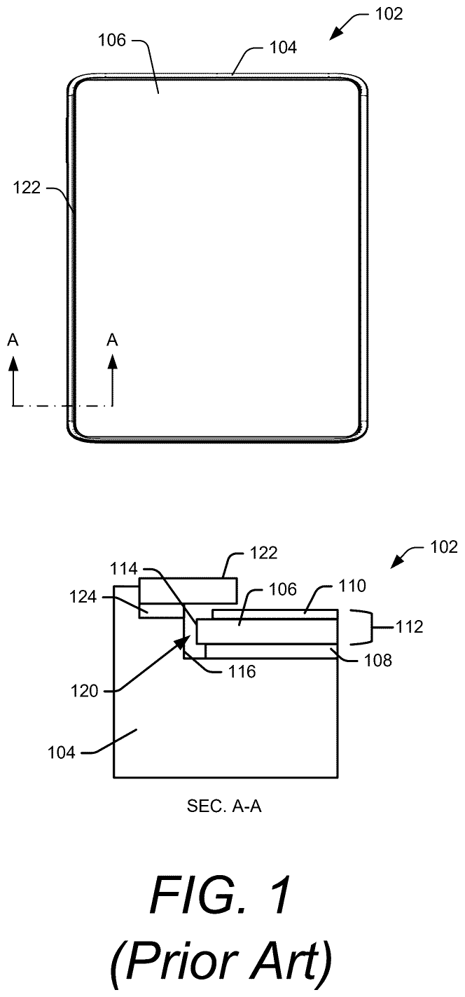

Foldable electronic devices often include a bezel (e.g., an inner display bezel, a display trim, a trim piece, a plastic housing component) located along a perimeter of the foldable display that is configured to protect the display panel stack. For example, an example prior art foldable electronic device 102 is illustrated in FIG. 1, which includes section view A-A. The electronic device 102 includes a housing 104 and a display panel 106 mounted in the housing 104. The display panel 106 may include multiple layers and may attach to the housing 104 via an adhesive portion 108. Due to the fragile nature of a display panel 106, at least portions of the display panel 106 may be positioned beneath a cover layer 110. The display panel 106 and cover layer 110 are collectively a “display panel stack 112.”

Moreover, because sides 114 (e.g., ends) of the display panel 106 may be particularly prone to damage, a clearance space 120 may be provided between the sides of the display panel 106 and the housing 104. When a foldable display is folded, some of the layers of the display panel 106 are configured to slide relative to one another to address stress within the display panel 106. The clearance space 120 in the housing 104 operates as a slack space that permits ends of the layers of the display panel 106 to freely move without contacting a wall 116 (e.g., side wall, end wall) of the housing 104. In this way, the sides 114 can be described as floating relative to the housing 104. Contact between a side 114 of the display panel 106 and the wall 116 (e.g., if the foldable electronic device 102 was dropped) may cause the cover layer 110 and/or the display panel 106 to break.

To prevent the ingress of contaminants (e.g., dust, water) into the clearance space 120, to visually hide the clearance space 120, and to physically protect the display panel 106 and cover layer 110, a bezel 122 may be positioned above the clearance space 120 and around a perimeter of the display panel 106. In this way, the bezel 122 covers and protects the edge of the display panel stack. The bezel 122 may attach to the housing 104 through an adhesive portion 124. Although such a solution may be functional, the foldable electronic device 102 of FIG. 1 may have limitations. For instance, the bezel 122 may interfere with a user's interaction at a touch interface on the display panel 106. Further, the bezel 122 may reduce the size of the active area of the display panel 106 and/or detract from a borderless aesthetic design appeal of the foldable electronic device 102, reducing user experience.

To this end, this document describes systems and techniques directed at bezel-less display mounts for foldable electronic devices. In aspects, a foldable electronic device includes a housing with opposing side walls, opposing end walls, and a bottom that interconnects the opposing side walls and the opposing end walls. The foldable electronic device includes a display recess that is defined between the opposing side walls, opposing end walls, and a bottom of the housing. The display recess may include a ledge that inwardly projects from at least one of the opposing side walls or the opposing end walls. The foldable electronic device includes a folding region that intersects a first non-folding region and a second non-folding region. At least one of the first non-folding region or the second non-folding region is/are configured to rotate about the folding region. The foldable electronic device includes a foldable display structure positioned in the display recess within at least portions of the first non-folding region of the housing and/or the second non-folding region of the housing.

The foldable display structure includes a display panel and a cover layer. The display panel includes a top face, a bottom face opposite the top face, and a plurality of light-emitting pixels disposed in the display panel. The cover layer is positioned as a topmost layer of the foldable display structure. The cover layer has a top face and a bottom face. The bottom face of the cover layer has an area larger than an area of the top face of the display panel to define an extension portion that extends beyond one or more edges of the display panel. The foldable electronic device includes a back adhesive portion disposed between the bottom face of the display panel and the bottom of the housing and a perimeter adhesive portion disposed between the extension portion of the cover layer and the ledge. As a result, by attaching the extension portion of the display panel to the housing at the ledge, the foldable electronic device can do away with a bezel (e.g., display trim) that would otherwise surround a perimeter of the display panel.

The following discussion describes operating environments and techniques that may be employed in the operating environments and example methods. Although this document describes systems and techniques directed at bezel-less display mounts for foldable electronic devices, the subject of the appended Claims is not necessarily limited to the specific features or methods described. Rather, the document discloses specific features and methods as example implementations and refers to the operating environment by way of example only.

### Example Implementations

The following discussion describes example implementations, techniques, apparatuses that may be employed in the example implementations, and various devices in which bezel-less display mounts for foldable electronic devices and the components thereof may be embodied.

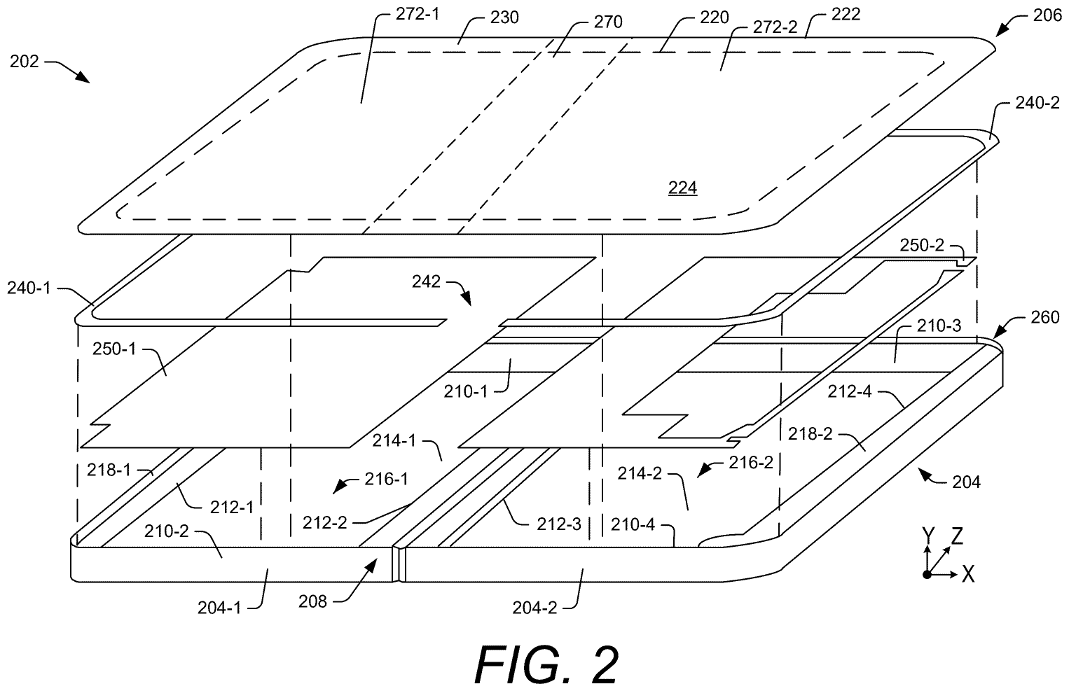

FIG. 2 is an exploded, perspective view of an example implementation of a foldable electronic device 202 that includes a bezel-less display mount in accordance with the present description. The example foldable electronic device 202 includes a housing 204 (e.g., a frame, an enclosure) and a foldable display structure 206 positioned in (e.g., mounted to) the housing 204. The housing 204 is configured to receive the foldable display structure 206. The housing 204 may include multiple sub-housings (e.g., sub-housing 204-1, sub-housing 204-2) hingedly connected at a hinge portion 208. The housing 204 may include opposing side walls (e.g., side wall 210-1, side wall 210-2, side wall 210-3, side wall 210-4), opposing end walls (e.g., end wall 212-1, end wall 212-2, end wall 212-3, end wall 212-4), and a bottom (e.g., bottom 214-1, bottom 214-2) that interconnects opposing side walls and opposing end walls. A display recess (e.g., display recess 216-1, display recess 216-2) is defined between the opposing side walls, opposing end walls, and the bottom of the housing 204. In aspects, the first display recess 216-1 and the second display recess 216-2 are defined in respective faces of the first and second non-folding regions.

The display recess may include a ledge (e.g., ledge 218-1, ledge 218-2) that inwardly projects (e.g., radially extends, annularly extends) from at least one of the opposing side walls and/or the opposing end walls. In aspects, the ledge is an enclosure step, a lip, and the like. The opposing side walls and opposing end walls of the housing 204 define a housing rim 260 (e.g., an enclosure rim). A gap is defined between the housing rim 260 and the edges of the display panel 220. The foldable electronic device 202 lacks a bezel that covers the gap (e.g., the edge of the cover layer is not hidden by a plastic bezel). In this way, the housing 204 is configured to receive the foldable display structure so that the combination of the housing and the foldable display structure lacks a bezel.

The display panel 220 is a foldable display that is configured to fold along one or more axes (e.g., a Z-axis). The display panel 220 includes one or more folding regions (e.g., folding region 270) about which one or more non-folding regions (e.g., first non-folding region 272-1, second non-folding region 272-2) may rotate (e.g., along a Y-axis). In FIG. 2, the foldable electronic device 202 is illustrated in its open configuration. The foldable display structure 206 is configured to be positioned in the display recess within at least portions of the first non-folding region 272-1 of the housing 204 and in the second non-folding region 272-2 of the housing 204.

The foldable display structure 206 includes a display panel 220. The display panel 220 may include multiple layers. For example, the display panel 220 may include one or more of a display panel module with pixel array and driving circuitry, a touch layer (e.g., touch sensor panel), a polarizer layer (e.g., polarization filters), an adhesive layer, a protective layer, or the like. The display panel 220 has a top face (hidden from view in FIG. 2) opposite a bottom face (hidden from view in FIG. 2) and a plurality of light-emitting pixels disposed in the display panel 220.

The display panel 220 may include a back plate (e.g., a metal backer, a display support structure, a steel display backing support). The metal back plate may be formed from a metal (e.g., copper or aluminum), an alloy (e.g., steel), composite materials (e.g., carbon fiber), and the like. The back plate may be configured to inhibit the flexing of the foldable display structure 206. One or more of the layers of a display panel 220 may be configured to slip (e.g., display slip) relative to one another (e.g., when the foldable electronic device is in a closed state) to relieve stresses and strains that are stored within the display layers to avoid delamination, yielding, and/or failures of the display panel 220.

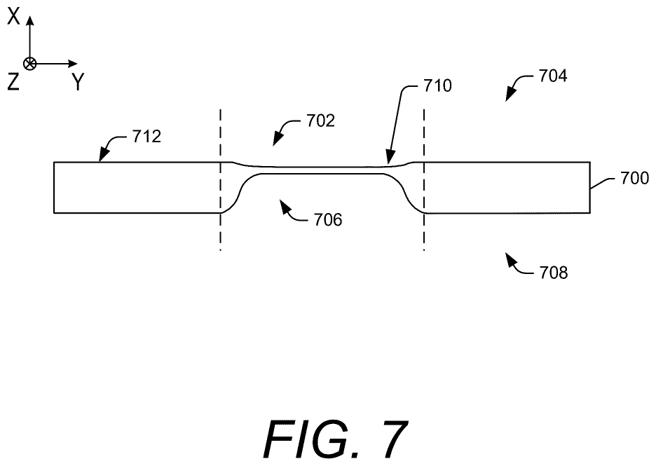

The foldable display structure 206 includes a cover layer 222 (e.g., cover glass, glass panel) configured to protect the display panel 220 from damage (e.g., physical damage). In implementations, the cover layer 222 may include a variable thickness along at least one dimension of the foldable electronic device 202 and/or the display panel 220 (e.g., a width of the device, along an axis perpendicular to a folding axis). The variable thickness cover layer 222 is further described below with respect to FIG. 7. The edge of the variable thickness cover layer 222 is configured to survive impacts and/or a user's touch force on the edges of the cover layer 222 during use. Because of the thicker portion of the variable thickness cover layer 222, the cover layer 222 can be directly attached to the housing 204 at the ledge 218. In other implementations, the cover layer 222 is uniformly thick transparent material.

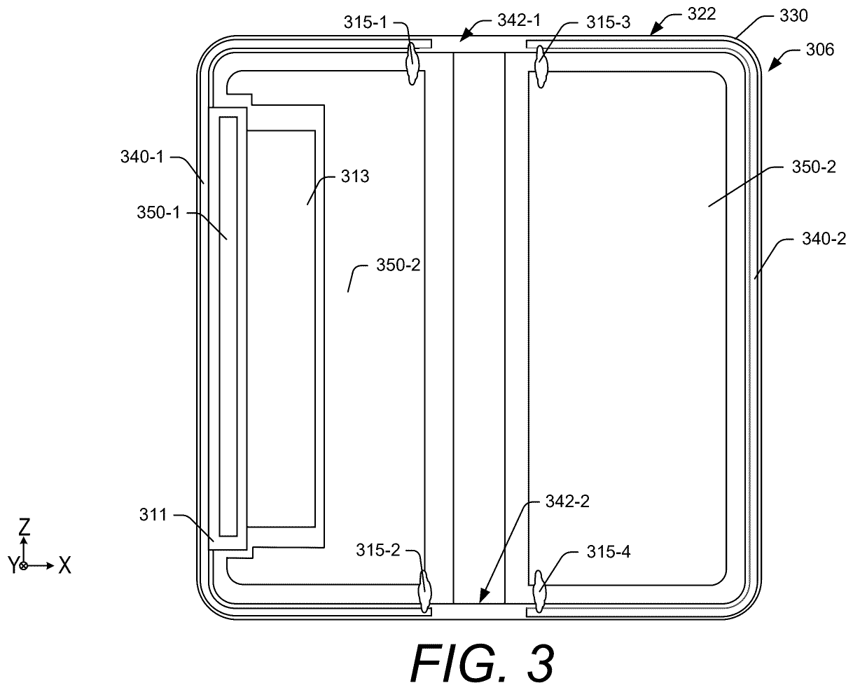

The cover layer 222 includes a top face 224 opposite a bottom face (hidden from view in FIG. 2). In aspects, the cover layer 222 may be larger than the display panel 220 in at least one dimension (e.g., a length, a width). For example, the bottom face (hidden from view in FIG. 2) of the cover layer 222 may have an area larger than an area of the top face (not illustrated in FIG. 2) of the display panel 220 to define an extension portion 230 of the cover layer 222 that may extend beyond one or more edges of the display panel 220. In this configuration, the cover layer 222 is configured to extend beyond the display panel 220 to a position adjacent to (e.g., abuts) the housing 204. For example, as illustrated and described with respect to the foldable display structure 306 of FIGS. 3, 4, 5A, 5B, 6A, and 6B. Thus, the cover layer 222 may protect the display panel 220, including edges of the display panel 220, from environmental contaminants and external forces. For example, the extension portion 230 may prevent the ingress of contaminants from entering a clearance space located between the sides of the display panel 220 and the housing 204. In another example, the extension portion 230 may visually hide the clearance space from view. In a further example, the extension portion 230 may physically protect the display panel 220 (e.g., the fragile ends of the layers of the display panel 220). In this way, the extension portion 230 does not interfere with a user's interaction at a touch interface on the display panel 220, maintains the size of the active area of the display panel 220, and does not detract from a borderless aesthetic design appeal of the foldable electronic device 202. The cover layer 222 may extend past a perimeter of the back plate (e.g., a metal backer) of the display panel 220, as illustrated and described with respect to the foldable electronic device 302 of FIGS. 3, 4, 5A, 5B, 6A, and 6B.

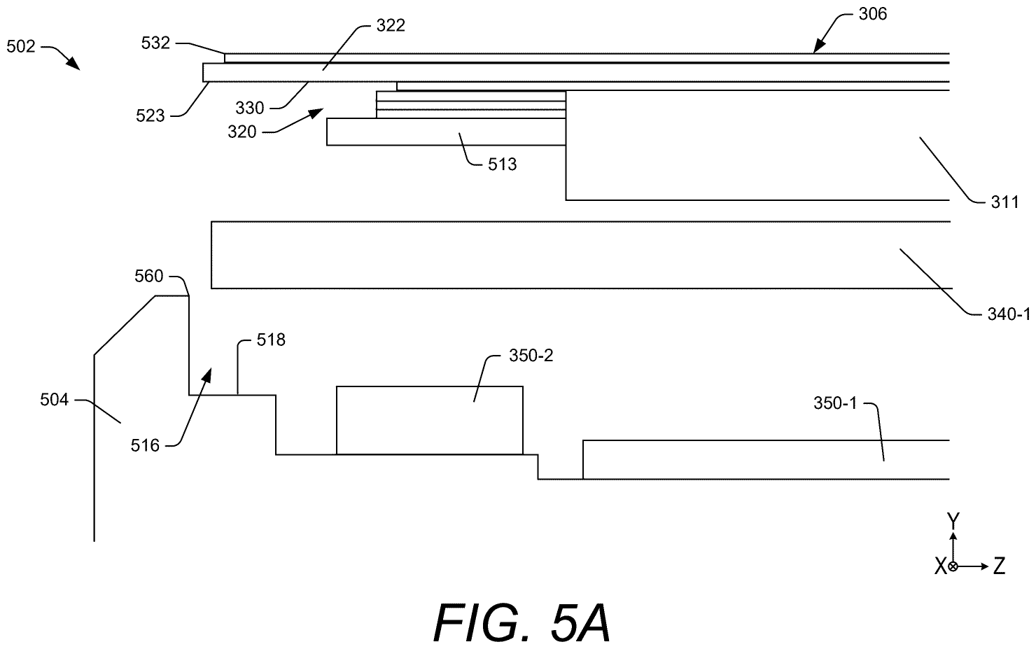

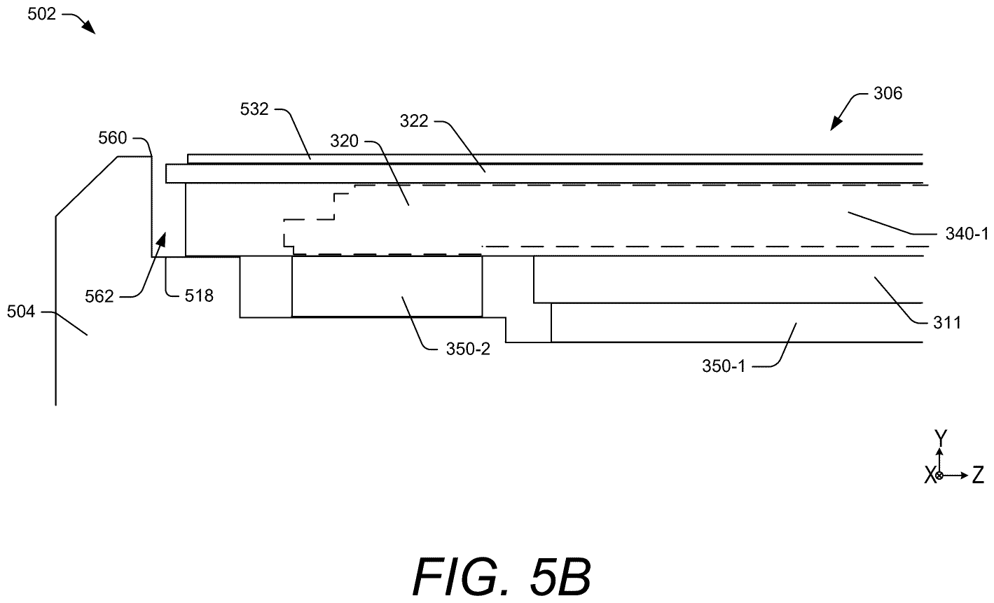

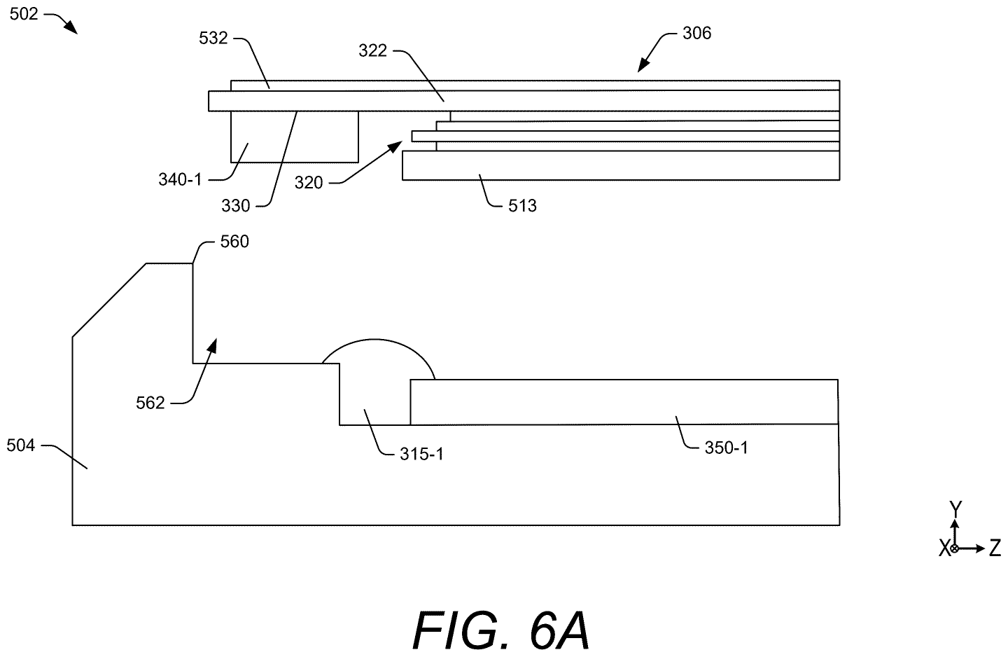

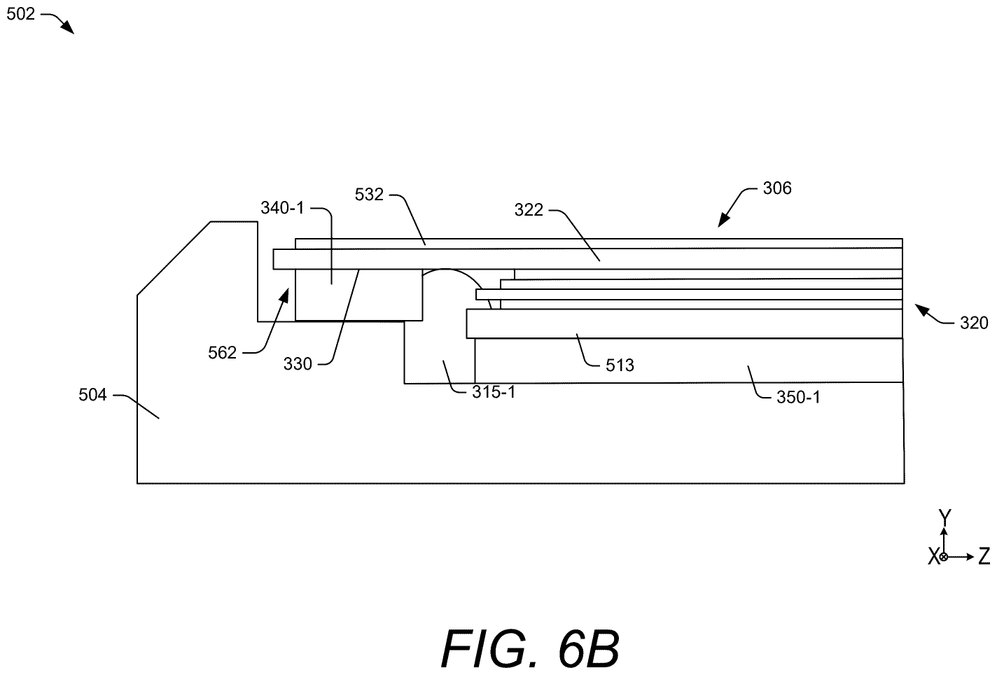

The foldable display structure 206 may include an extended display protective layer (e.g., protective film, glass protection layer, polyethylene terephthalate (PET) film) disposed on (e.g., positioned on) the top face 224 of the cover layer 222. An example extended display protective layer is illustrated and described with respect to FIGS. 5A and 6A below. In aspects, the extended display protective layer may include an opaque border (e.g., ink mask, black mask) applied to the edge (e.g., underside) of the cover layer 222. The extended display protective layer may extend beyond the extension portion 230 of the cover layer 222 to cover at least a portion of the gap defined between the housing rim 260 and the edges of the display panel 220.

The extension portion 230 of the cover layer 222 of the foldable display structure 206 may be configured to attach to the ledge 218 of the housing 204 via a perimeter adhesive portion (e.g., perimeter adhesive portion 240-1, perimeter adhesive portion 240-2). For example, a first portion of the extension portion 230 may attach at ledge 218-1 via perimeter adhesive portion 240-1 and a second portion of the extension portion 230 may attach at ledge 218-2 via perimeter adhesive portion 240-2. In this way, the perimeter adhesive portion 240 is disposed between the extension portion 230 of the cover layer 222 and the ledge 218 of the housing 204, and the cover layer 222 is directly attached (e.g., via perimeter adhesive portion) to the housing 204. The perimeter adhesive portions may be spaced apart from one another.

In aspects, the extension portion of the cover layer of the foldable display structure is formed with a tolerance that enables the extension portion to seal the device to prevent the ingress of contaminants without the utilization of a perimeter adhesive portion between the cover layer and the ledge. In aspects, the perimeter adhesive portion located adjacently to a first side wall of the opposing side walls may be configured to flex towards the first side wall when at least one of the first non-folding region or the second non-folding region are rotated about the folding region to orient the foldable electronic device in a closed status.

In aspects, at least one void (e.g., void 242, void 342-1, void 342-2) or other interruption may be defined in the perimeter adhesive portion. In this way, a perimeter adhesive portion may be configured as two separate perimeter adhesive portions. For example, a first void may be defined in the perimeter adhesive portion 240-1 at the first side of the folding region, with the first void defined between a first end of the perimeter adhesive portion and a second end of the perimeter adhesive portion, and a second void may be defined in the perimeter adhesive portion at the second side of the folding region, with the second void defined between a third end of the perimeter adhesive portion and a fourth end of the perimeter adhesive portion.

A bottom face (hidden from view in FIG. 2) of the display panel 220 of the foldable display structure 206 may be configured to attach to a bottom (e.g., bottom 214-1, bottom 214-2) of the housing 204 via a back adhesive portion (e.g., back adhesive portion 250-1, back adhesive portion 250-2). For example, a first portion of the display panel 220 may attach via back adhesive portion 250-1 to bottom 214-1 and a second portion of the display panel 220 may attach via back adhesive portion 250-2 to bottom 214-2. In this way, the back adhesive portion 250 is disposed between the bottom face of the display panel 220 and the bottom 214 of the housing 204. Suitable adhesive portions for back adhesive portions and perimeter adhesive portions of bezel-less display mounts for foldable electronic devices described herein include pressure sensitive adhesives (PSA) and adhesive tapes.

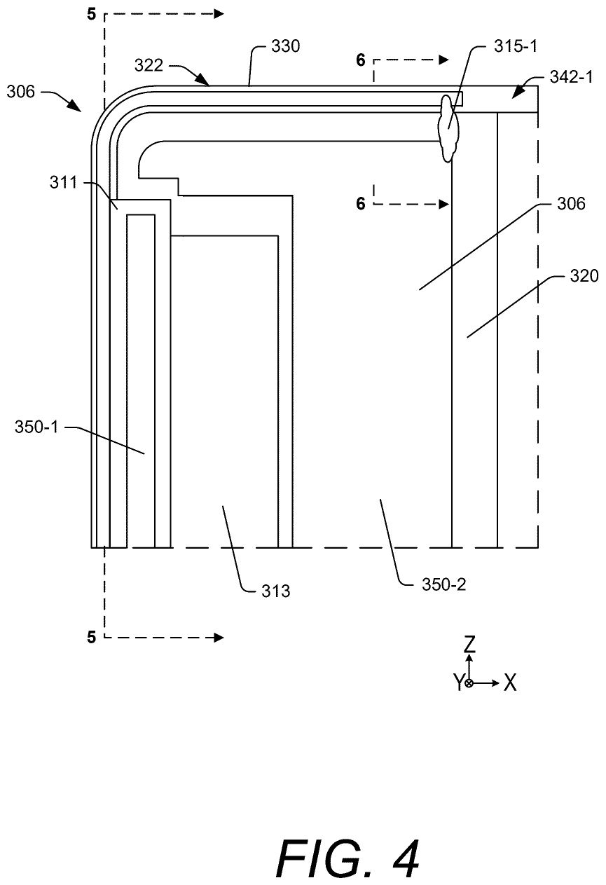

The discussion now turns to FIGS. 3, 4, 5A, 5B, 6A, and 6B. FIG. 3 is a bottom side view and FIG. 4 is a partial, bottom side view of a foldable display structure 306 of a foldable electronic device 502, which is further illustrated in the cross-sectional views of FIGS. 5A, 5B, 6A, and 6B. The foldable electronic device 502 includes a bezel-less display mount in accordance with the present description.

The foldable electronic device 502 is similar to the foldable electronic device 202 illustrated in FIG. 2 and described above, except as detailed below. Thus, the foldable electronic device 502 includes a housing 504, a foldable display structure 306, a hinge portion (not illustrated), opposing side walls 510, opposing end walls (not illustrated), a bottom 514, a display recess 516, a ledge 518, a display panel 320, a display panel top face opposite a bottom face, a back plate 513, a cover layer 322, a cover layer top face (hidden from view) opposite a bottom face 523, an extension portion 330, an extended display protective layer 532, a perimeter adhesive portion (e.g., perimeter adhesive portion 340-1, perimeter adhesive portion 340-2), a first void 342-1, a second void 342-2, a bottom face of the display panel, and a back adhesive portion (e.g., back adhesive portion 350-1, back adhesive portion 350-2, back adhesive portion 350-3). The extended display protective layer 532 may extend beyond the extension portion 330 of the cover layer 322 to cover at least a portion of the gap 562 defined between the housing rim 560 and the edges of the display panel 520.

The cover layer 322 is configured to protect the display panel 320 from damage. In implementations, the cover layer 322 may include a variable thickness along at least one dimension of the foldable electronic device 202 and/or the display panel 320 (e.g., a width of the device, along an axis perpendicular to a folding axis). The variable thickness cover layer 322 is further described below with respect to FIG. 7. The edge of the variable thickness cover layer 322 is configured to survive impacts and/or a user's touch force on the edges of the cover layer 322 during use. Because of the thicker portion of the variable thickness cover layer 322, the cover layer 322 can be directly attached to the housing 504 at the ledge 518. In other implementations, the cover layer 322 is uniformly thick transparent material.

The opposing side walls and the opposing end walls of the housing 504 define a housing rim 560 (e.g., an enclosure rim). A gap 562 is defined between the housing rim 560 and the edges of the display panel 520. The foldable electronic device 302 lacks a bezel that covers the gap 562 (e.g., the edge of the cover layer is not hidden by a plastic bezel). In this way, the housing 304 is configured to receive the foldable display structure 206 so that the combination of the housing 504 and the foldable display structure 206 lacks a bezel.

The foldable display structure 306 illustrated in FIGS. 3, 4, 5A, 5B, 6A, and 6B includes a display panel bending portion 311 and a display flex cable 313 (e.g., display flex), which may be common in foldable electronic devices. The foldable electronic device 502 includes a sealing material (e.g., a liquid gasket (for example, formed-in-place gasket (FIPG), cured-in-place gasket (CIPG)), flexible adhesive, sealant, dispensed glue material)) that is configured to seal the foldable electronic device 502 by interconnecting one or more of the perimeter adhesive portion(s) with one or more of the back adhesive portion(s) to block the ingress of contaminants (e.g., dust, water). The sealing material can be applied to the housing and/or the foldable display structure.

FIG. 3 illustrates sealing material 315-1 and sealing material 315-2 applied between the perimeter adhesive portion 340-1 and the back adhesive portion 350-2 at opposite sides of the foldable display structure 306, adjacent to the folding region. In such a configuration, the sealing material 315-1 extend between the first end of the perimeter adhesive portion 340-1 and the back adhesive portion 350-2 and/or the sealing material 315-2 may extend between the second end of the perimeter adhesive portion 340-1 and the back adhesive portion 350-2. Further, sealing material 315-3 may extend between the third end of the second perimeter adhesive portion 340-2 and the third back adhesive portion 350-3 and/or sealing material 315-4 may extend between the fourth end of the perimeter adhesive portion 340-2 and the third back adhesive portion 350-3.

FIG. 3 further illustrates sealing material 315-3 and sealing material 315-4 applied between the perimeter adhesive portion 340-2 and the back adhesive portion 350-3 at opposite sides of the foldable display structure 306, adjacent to the folding region. In FIGS. 6A and 6B, the sealing material 315-1 is illustrated as applied to the housing 504. In this way, the sealing connection between the adhesive portions forms a closed loop which may prevent the ingress of contaminants (e.g., water, dust) into the housing and in configurations, the sealing connection protects the display panel bending 311 from the ingress of contaminants.

As described above, a foldable display structure (e.g., foldable display structure 206, foldable display structure 306) includes a cover layer (e.g., cover layer 222, cover layer 322) that is configured to protect the display panel (e.g., display panel 220, display panel 320) from damage. In implementations, the cover layer (e.g., cover layer 222, cover layer 322) may include a variable thickness along at least one dimension of the foldable electronic device and/or the display panel (e.g., the width of the device, along an axis perpendicular to a folding axis). In aspects of the bezel-less display mounts for foldable electronic devices disclosed herein, because of the thicker portion of the variable thickness cover layer, the cover layer can be directly attached to the housing at the ledge, as described above.

FIG. 7 is a schematic illustration of an aspect of a variable thickness cover layer, as disclosed in Pre-Grant Publication US20240179859A1, titled “Trimless Foldable Displays,” application Ser. No. 18/434,210, filed Feb. 6, 2024, the disclosure of which is incorporated by reference. The example implementation illustrated in FIG. 7 is for example only and should not be considered as a limitation. FIG. 7 illustrates a cover layer 700 that includes a first groove 702 on a top face 704 and a second groove 706 on a bottom face 708. The first groove 702 and the second groove 706 form a variable thickness in the cover layer 700 along at least one dimension of the cover layer 700 (e.g., a dimension perpendicular to the length of the groove, the Y-axis). The first groove 702 and the second groove 706 may define, in the cover layer 700, a thin region 710 and at least one thick region 712. In implementations, a ratio of the dimensional-thickness between the thick region 712 and the thin region 710 may be at least six-to-one. In one example, the thick region 712 may be 200 micrometers thick, while the thin region 710 may be 30 micrometers thick. While other foldable display structures may utilize, for example, ultra-thin glass that is at 70-100 micrometers thick, the cover layer 700 may be much thicker, providing better reliability and hardness.

### Operating Environment

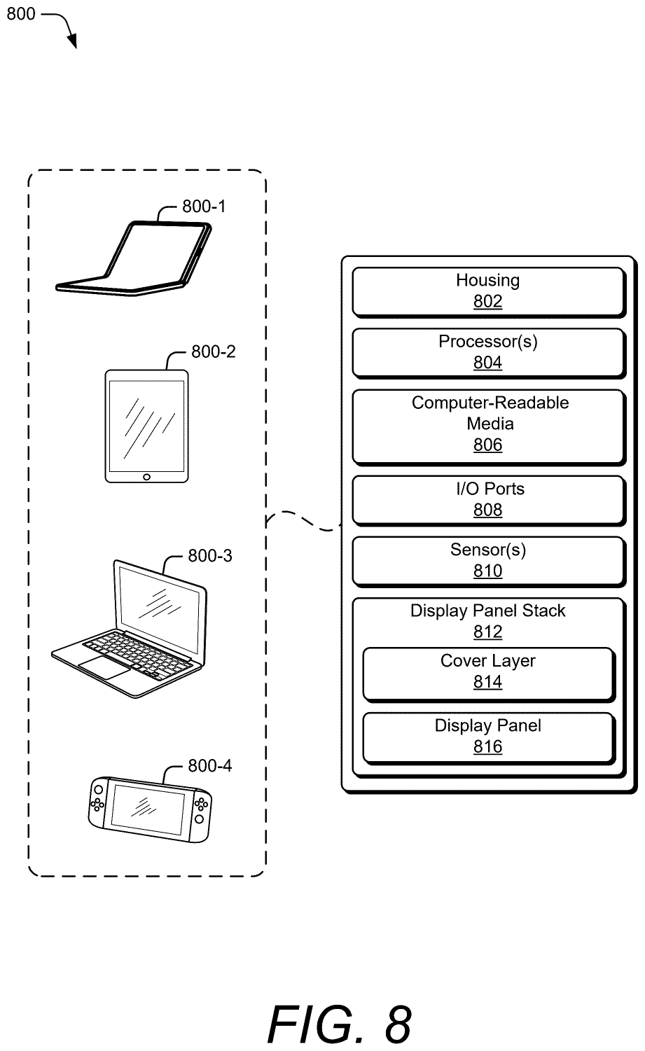

FIG. 8 illustrates example foldable electronic devices 800 (e.g., foldable electronic device 202, foldable electronic device 302) in which bezel-less display mounts can be implemented. The foldable electronic devices 800 may include additional components and interfaces omitted from FIG. 8 for the sake of clarity. The foldable electronic devices 800 can be any of a variety of consumer electronic devices. As non-limiting examples, the foldable electronic device 800 can be a mobile phone 800-1, a tablet device 800-2, a laptop computer 800-3, a portable video game console 800-4, and the like.

The foldable electronic device 800 includes the housing 802, which defines at least one internal cavity within which one or more of a plurality of electronic components may be disposed. In implementations, a mechanical frame may define one or more portions of the housing 802. As an example, a mechanical frame can include plastic or metallic walls that define portions of the housing 802. In additional implementations, a mechanical frame may support one or more portions of the housing 802. As an example, one or more exterior housing components (e.g., plastic panels) can be attached to the mechanical frame (e.g., a chassis). In so doing, the mechanical frame physically supports the one or more exterior housing components, which define portions of the housing 802. In any implementation, the housing 802 may be sealed through the inclusion of a display (e.g., the cover layer 814), defining at least one internal cavity.

The foldable electronic device 800 may further include one or more processor(s) 804. The processor(s) 804 can include, as non-limiting examples, a system on a chip (SoC), an application processor (AP), a central processing unit (CPU), or a graphics processing unit (GPU). The processor(s) 804 generally execute commands and processes utilized by the foldable electronic device 800 and an operating system installed thereon.

The foldable electronic device 800 may also include computer-readable storage media (CRM) 806. The CRM 806 may be a suitable storage device configured to store device data of the foldable electronic device 800, user data, and multimedia data. The CRM 806 may store an operating system that generally manages hardware and software resources (e.g., the applications) of the foldable electronic device 800 and provides common services for applications stored on the CRM 806. The operating system and the applications are generally executable by the processor(s) 804 to enable communications and user interaction with the foldable electronic device 800. One or more processor(s) 804, such as a GPU, perform operations to display graphics of the foldable electronic device 800 on the display panel 816 and can perform other specific computational tasks.

The foldable electronic device 800 may also include input/output (I/O) ports 808 that allow the foldable electronic device 800 to interact with other devices or a user. The I/O ports 808 may include any combination of internal or external ports, such as universal serial bus (USB) ports, audio ports, Serial ATA (SATA) ports, PCI-express based ports, or card-slots, secure digital input/output (SDIO) slots, and/or other legacy ports.

The foldable electronic device 800 may further include one or more sensors 810. The sensor(s) 810 can include any of a variety of sensors, such as an audio sensor (e.g., a microphone), a touch-input sensor (e.g., a touchscreen), an image-capture device (e.g., a camera, video-camera), proximity sensors (e.g., capacitive sensors), an under-display fingerprint sensor, or an ambient light sensor (e.g., photodetector).

Further, the foldable electronic device 800 includes the display panel stack 812 having the cover layer 814 and the display panel 816. The cover layer 814 may be implemented as any of a variety of transparent materials including polymers (e.g., plastic, acrylic) or glasses. The cover layer 814 may form any foldable, three-dimensional shape. The display panel 816 may include a two-dimensional pixel array (not illustrated in FIG. 8) forming a grid, operably coupled to one or more row-line drivers via electrical traces. The pixel array emits light to create an image on the display panel 816 upon electrical activation by one or more drivers.

### Interpretation

Unless context dictates otherwise, use herein of the word “or” may be considered use of an “inclusive or,” or a term that permits inclusion or application of one or more items that are linked by the word “or.” Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

For clarity, a Cartesian coordinate system is used and is labeled in the Drawings. The coordinate system includes three dimensions, namely, an X-axis, a Y-axis, and a Z-axis. Each of the three axes is orthogonal to the other two axes. The X-axis and the Y-axis define a horizontal plane, with the Z-axis in a vertical direction. While the origin of the coordinate system may be placed at any point on or near the components of a foldable electronic device, for the purposes of description, the axes of the coordinate system are always disposed along the same directions from figure to figure, unless indicated otherwise. In some examples, reference may be made to dimensions, angles, directions, relative positions, and/or movements associated with one or more components of a foldable electronic device with respect to the coordinate system. For instance, the length of a foldable electronic device may be defined as a dimension along the X-axis, the thickness of the foldable electronic device may be defined as a dimension along the Y-axis, and the width of the foldable electronic device may be defined as a dimension along the Z-axis of the coordinate system.

Terms such as “above,” “below,” or “underneath” are not intended to require any particular orientation of a device. Rather, a first layer or component, being provided “above” a second layer or component is intended to describe the first layer being at a higher Z-dimension than the second layer of component within the particular coordinate system in use. It will be understood that should the component be provided in another orientation, or described in a different coordinate system, then such relative terms may be changed.

### CONCLUSION

Although implementations directed at bezel-less display mounts for foldable electronic devices have been described in language specific to certain features and/or methods, the subject of the appended Claims is not necessarily limited to the specific features or methods described. Rather, the specific features and methods are disclosed as example implementations directed at bezel-less display mounts for foldable electronic devices.

What is claimed is:

1. A foldable electronic device comprising:
a housing comprising:
opposing side walls;
opposing end walls;
a bottom that interconnects the opposing side walls and opposing end walls;
a display recess defined between the opposing side walls, opposing end walls, and a bottom of the housing, the display recess includes a ledge that inwardly projects from at least one of the opposing side walls or the opposing end walls;
a folding region that intersects a first non-folding region and a second non-folding region, at least one of the first non-folding region or the second non-folding region configured to rotate about the folding region;
a foldable display structure positioned in the display recess within at least portions of the first non-folding region of the housing and the second non-folding region of the housing, the foldable display structure comprising:
a display panel having a top face, a bottom face opposite the top face, and a plurality of light-emitting pixels disposed in the display panel; and
a cover layer positioned as a topmost layer of the foldable display structure, the cover layer including a variable thickness along at least one dimension, the cover layer having a top face and a bottom face, the bottom face of the cover layer having an area larger than an area of the top face of the display panel to define an extension portion that extends beyond one or more edges of the display panel;
a back adhesive portion disposed between the bottom face of the display panel and the bottom of the housing; and
a perimeter adhesive portion disposed between the extension portion of the cover layer and the ledge.

2. The foldable electronic device of claim 1,
wherein the opposing side walls and opposing end walls of the housing define a housing rim, and
wherein the foldable electronic device further comprises:
a gap defined between the housing rim and the edges of the display panel, wherein the foldable electronic device lacks a bezel that covers the gap.

3. The foldable electronic device of claim 2, further comprising:
an extended display protective layer positioned on the display panel, the extended display protective layer extends beyond the extension portion of the cover layer to cover at least a portion of the gap.

4. The foldable electronic device of claim 1, further comprising:
a first void defined in the perimeter adhesive portion at a first side of the folding region, the first void defined between a first end of the perimeter adhesive portion and a second end of the perimeter adhesive portion; and
a second void defined in the perimeter adhesive portion at a second side of the folding region, the second void defined between a third end of the perimeter adhesive portion and a fourth end of the perimeter adhesive portion.

5. The foldable electronic device of claim 1, wherein the back adhesive portion comprises at least one of:
a first back adhesive portion disposed between the bottom face of the display panel and the bottom of the housing on a first side of the folding region in the first non-folding region; or
a second back adhesive portion disposed between the bottom face of the display panel and the bottom of the housing on a second side of the folding region in the second non-folding region.

6. The foldable electronic device of claim 5, further comprising:
a sealing material is positioned to limit an ingress of contaminants into at least one of the first or second non-folding regions of the housing, the sealing material extends between at least one of:
a first end of the perimeter adhesive portion and the first back adhesive portion;
a second end of the perimeter adhesive portion and the second back adhesive portion;
a third end of the perimeter adhesive portion and the first back adhesive portion; or
a fourth end of the perimeter adhesive portion and the second back adhesive portion.

7. The foldable electronic device of claim 6, wherein the sealing material is a formed-in-place gasket.

8. The foldable electronic device of claim 1,
wherein the opposing side walls and opposing end walls of the housing define a housing rim, and
wherein the perimeter adhesive portion located adjacent a first side wall of the opposing side walls is configured to flex towards the first side wall when at least one of the first non-folding region or the second non-folding region are rotated about the folding region to orient the foldable electronic device in a closed status.
